(19) United States
(12) Patent Application Publication
(10) Pub. No.: US 2018/0290908 A1
(43) Pub. Date: Oct. 11, 2018

(54) WATER TREATMENT SYSTEM FOR SIMULTANEOUS NITRIFICATION AND DENITRIFICATION

(71) Applicants: Dean Smith, Thousand Oaks, CA (US); Ola Lysenstoen, Newbury Park, CA (US); Cary Tope-McKay, Malibu, CA (US); Gary Gorian, Westlake Village, CA (US)

(72) Inventors: Dean Smith, Thousand Oaks, CA (US); Ola Lysenstoen, Newbury Park, CA (US); Cary Tope-McKay, Malibu, CA (US); Gary Gorian, Westlake Village, CA (US)

(21) Appl. No.: 16/005,471

(22) Filed: Jun. 11, 2018

Related U.S. Application Data
(63) Continuation-in-part of application No. 13/315,276, filed on Dec. 8, 2011, now Pat. No. 10,046,997.
(60) Provisional application No. 61/421,153, filed on Dec. 8, 2010.
(60) Provisional application No. 61/497,482, filed on Jun. 15, 2011.

(51) Int. Cl. C02F 3/30; C02F 3/06; C02F 3/28

(52) U.S. Cl. CPC C02F 3/301; C02F 3/302; C02F 2101/163; C02F 3/2806; C02F 3/06

(57) ABSTRACT

Described herein is a water treatment system for simultaneously removing ammonia and nitrates from a liquid. The water treatment system comprises a floating platform, at least one columnar unit connected with the floating platform, where each columnar unit includes a bounding surface possessing multiple apertures. An air diffuser is connected with each columnar unit for supplying an air flow volume within the columnar unit.

### CROSS-REFERENCE TO RELATED APPLICATIONS

This is a Continuation-in-Part patent application of U.S. application Ser. No. 13/315,276, filed in the United States on Dec. 8, 2011, entitled, “Water Treatment System for Simultaneous Nitrification and Denitrification,” which is a Non-Provisional patent application of U.S. Provisional Application No. 61/421,153, filed in the United States on Dec. 8, 2010, entitled, “Self-Contained Anoxic Device,” and U.S. Provisional Application No. 61/497,482, filed in the United States on Jun. 15, 2011, entitled, “Water Treatment System for Simultaneous Nitrification and Denitrification,” the entirety of which are hereby incorporated by reference.

### BACKGROUND OF THE INVENTION

### (1) Field of Invention

The present invention relates to a water treatment system and, more particularly, to a water treatment system for simultaneous nitrification and denitrification.

### (2) Description of Related Art

Water treatment, also referred to as sewage treatment, involves removing contaminants from wastewater and household sewage. Several processes are used to remove physical, chemical, and biological contaminants. Typically, a water treatment system utilizes three stages: primary, secondary, and tertiary treatment. Primary treatment involves containing the sewage to allow heavy solids to settle at the bottom of a basin, while oil, grease, and lighter solids float to the top. The liquid that remains after removal of the settled and floating materials is then subjected to a secondary treatment. The secondary treatment consists of removing dissolved and suspended biological matter using microorganisms (e.g., bacteria, protozoans). Finally, tertiary treatment is considered any further treatment of the water which improves the quality of the water prior to discharge to the receiving environment, such as disinfection.

One significant objective in secondary treatment is the reduction of nitrates, which are toxic and must be kept at low levels in accordance with the Environmental Protection Agency (EPA). Additionally, it is important to reduce ammonia levels during water treatment. The removal of nitrogen occurs through the biological oxidation of nitrogen from ammonia, or nitrification, followed by denitrification, which is the reduction of nitrate to nitrogen gas. Ammonia conversion generally occurs under aerobic conditions, while nitrate conversion generally occurs under anoxic/low oxygen conditions. In some cases, however, conversion of ammonia can also occur under anaerobic conditions. Nitrification itself is a two-step aerobic process, each step facilitated by a different type of bacteria. Denitrification generally requires anoxic conditions to encourage the appropriate biological communities to form and is facilitated by a wide diversity of bacteria. Currently, water treatment systems have separate aerobic and anoxic zones, or regions, in aeration basins for ammonia and nitrate conversion, respectively.

Thus, a continuing need exists for a cost-efficient water treatment system which serves the dual purpose of reducing ammonia and nitrate levels in water using a single device.

### SUMMARY OF INVENTION

The present invention relates to a water treatment system and, more particularly, to a water treatment system for simultaneous nitrification and denitrification. The system comprises a floating platform; at least one columnar unit connected with the floating platform, each columnar unit having a top, a bottom, and a bounding surface extending from the top to the bottom, wherein the bounding surface possesses a plurality of apertures. The system further comprises an air diffuser connected with the at least one columnar unit for supplying an air flow volume within the at least one columnar unit, a compressed air supply, and a power supply.

In another aspect, the system further comprises a propulsion mechanism attached with the floating platform.

In another aspect, the system further comprises a substrate for bacterial growth residing within the at least one columnar unit.

In another aspect, the system further comprises at least one solar panel attached with the floating platform.

In another aspect, the system further comprises a frame for attaching the at least one columnar unit with the floating platform.

In another aspect, the floating platform is anchored to one of a bottom of a fluid body and a side of a structure.

In another aspect, the system further comprises at least one sensor for recording chemical data.

In another aspect, the at least one sensor is a dissolved oxygen sensor for monitoring aeration inside the at least one columnar unit.

In another aspect, the system further comprises a processor for receiving instructions for controlling the propulsion mechanism for autonomous movement.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a water treatment system comprising an columnar unit and a floating platform according to some embodiments of the present disclosure;

FIG. 2 is an illustration of a water treatment system comprising a plurality of columnar units and a floating platform according to some embodiments of the present disclosure;

FIG. 3 is an illustration of a water system anchored to the bottom of a fluid body according to some embodiments of the present disclosure;

FIG. 4A is an illustration of a columnar unit according to some embodiments of the present disclosure;

FIG. 4B is an illustration of a columnar unit having a substrate for bacterial growth according to some embodiments of the present disclosure;

FIG. 5 is an illustration of a water treatment system having a horizontal arrangement of a plurality of columnar units and a floating platform according to some embodiments of the present disclosure;

FIG. 6 is an illustration of a water treatment system having a cross arrangement of a plurality of columnar units and a floating platform according to some embodiments of the present disclosure;

FIG. 7 is an illustration of a water treatment system having a propulsion mechanism according to some embodiments of the present disclosure;

FIG. 8 is an illustration of a water treatment system having sensors and being anchored by a winch according to some embodiments of the present disclosure;

FIG. 9 is an illustration of a water treatment system anchored by a winch according to some embodiments of the present disclosure;

FIG. 10 is an illustration of a water treatment system anchored to the side of a structure according to some embodiments of the present disclosure; and

FIG. 11 is a block diagram depicting the components of a system for controlling a water treatment system according to some embodiments of the present disclosure.

### DETAILED DESCRIPTION

The present invention relates to a water treatment system and, more particularly, to a water treatment system for simultaneous nitrification and denitrification. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention.

However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Specific Details

The present invention relates to a device which can be used to simultaneously decrease levels of ammonia and nitrates in a water treatment system. Nitrogen removal is a step in the secondary treatment stage of water treatment. The removal of nitrogen occurs through the biological oxidation of nitrogen from ammonia, or nitrification, followed by denitrification, which is the reduction of nitrate to nitrogen gas. Ammonia conversion occurs under aerobic conditions, while nitrate conversion occurs under anoxic conditions. Nitrification itself is a two-step aerobic process, each step facilitated by a different type of bacteria. Denitrification requires anoxic conditions to encourage the appropriate biological communities to form. It is facilitated by a wide diversity of bacteria.

Currently, water treatment systems have separate aerobic and anoxic tanks (or basins) or the tanks (or basins) are divided into zones for ammonia and nitrate conversion, respectively. Additionally, basins may also be divided into zones alternating between aerobic and anoxic states. The system comprises a nitrifying volume for nitrification of a liquid and a denitrifying volume for denitrification of the liquid. One of the nitrifying volume and the denitrifying volume resides substantially within the other of the nitrifying volume and the denitrifying volume, which will be hereinafter referred to as the inner volume. Furthermore, the nitrifying volume and the denitrifying volume are in fluid communication. The nitrifying volume is a relatively oxygenated (i.e., aerobic) region, and the denitrifying volume is a relatively oxygen-depleted (i.e., anoxic) region.

In one aspect, the water treatment system functions on the principle of counter-current exchange which, along with convection and diffusion, allows for the reduction of ammonia and a reduction of nitrate to take place simultaneously. However, the water treatment system can also function without counter-current exchange. Countercurrent exchange, along with convection and diffusion, allows for the reduction of ammonia and a reduction of nitrate to take place. In the present invention, the water treatment system can create an anoxic environment in the inner volume, for example, and an aerobic environment on the outside of the inner volume (i.e., outer volume). Alternatively, the water treatment system can create an anoxic environment on the outside of the inner volume (i.e., outer volume) and an aerobic environment inside the inner volume.

In the aerobic environment, ammonia is oxidized to hydroxylamine via ammonia monooxygenase. Hydroxylamine is then converted to nitrite by another oxidizing enzyme called hydroxylamine oxidoreductase. Nitrite is then oxidized to nitrate by yet another oxidizing enzyme. The process of ammonia being converted into nitrate is known as the nitrifying process and is generally done in the presence of oxygen (i.e., an aerobic region). However, the buildup of the intermediate molecules, particularly nitrite, is inhibitory on the activity of ammonia monooxygenase. Therefore, the oxidation of ammonia to nitrate via these enzymes causes problems with the reaction. Thus, an anoxic environment, such as that produced by the water treatment system, is beneficial in that it will “pull” the reaction forward so that the intermediate molecules do not accumulate.

As the ammonia concentration falls in the aerobic environment and the hydroxylamine, nitrite and nitrate concentrations rise in the aerobic environment, the reaction slows. In the interior anoxic region, the nitrates are eventually broken down into nitrogen gas. Therefore, the water treatment system described herein aids in preventing the build-up of intermediate molecules (e.g., nitrite), which are toxic or inhibit the total reaction in the aerobic region. With two microenvironments in close proximity, the reaction runs smoothly without the excessive build-up of intermediate molecules, such as nitrite.

The water treatment system described creates an anoxic environment and an aerobic environment within a single fluid body (e.g., tank, basin, lake, pond, fish farm, anaerobic lagoon) that is more pixelated and, thus, more effective. Pixelation, in the context of the present application, refers to the “resolution” of the process. Similar to how improved resolution in a photograph allows one's eyes to make out finer detail, the smaller the inner volume (e.g., columnar units), or container, described in the present application, the better the reaction works. This is because mixing requirements drop, airflow requirements drop, and the reaction speeds up as a result of larger ratio of anoxic to aerobic space.

The present invention can be used to treat belt press filtrate effluent as well as traditional secondary treatment fluids. Specifically, the water treatment system can be utilized to treat wastewater that is significantly higher in ammonia content than secondary water. Levels of NH₃ in belt pressate or centrate effluent can range from several milligrams/liter (mg/L) to several grams/liter (g/L), whereas NH₃ levels of secondary treatment fluids typically range from 1 mg/L to 50 mg/L. Furthermore, the present invention is useful in the treatment of numerous other wastewater applications within industrial wastewater, landfill leachate, agricultural run-off, aquaculture (e.g., fish farms), and any other wastewater process where there is a high level of ammonia in the influent. In addition to use in wastewater treatment systems described above, the water treatment system described herein is also suitable for use within commercial water treatment facilities, non-limiting examples of which include poultry processing, breweries, canneries, and juice makers.

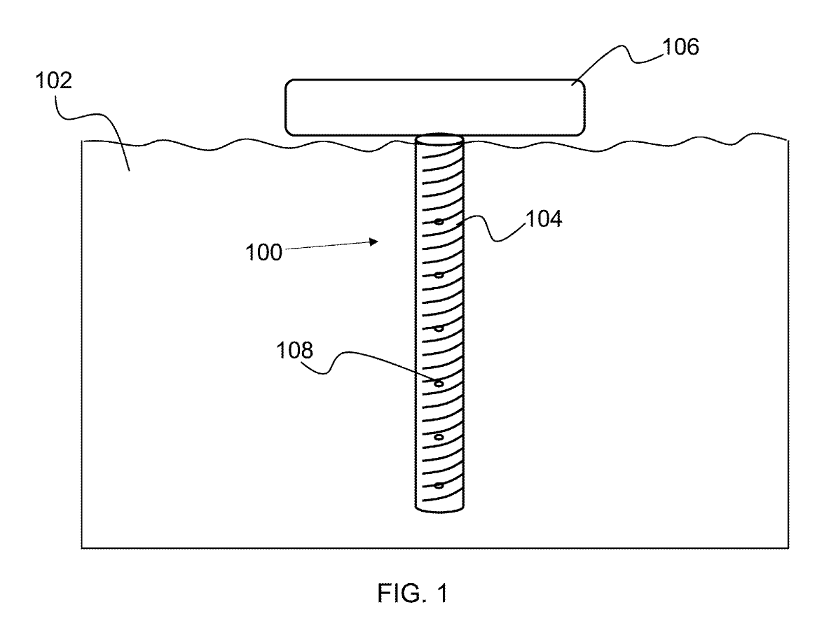

FIG. 1 is an illustration of one embodiment of the water treatment system 100.

One of the nitrifying volume and the denitrifying volume is a fluid body 102, which can be a natural fluid body 102 (e.g., lake, pond) or a man-made fluid body 102 (e.g., fish farm, anaerobic lagoon). The other of the nitrifying volume and denitrifying volume is a portion of the water treatment system 100 comprising at least one columnar unit 104, which resides substantially in the fluid body 102. The columnar unit 104 is attached with a floating platform 106, and together the columnar unit 104 (or units) and the floating platform 106 form the water treatment system 100 according to embodiments of the present disclosure. Specifically, the columnar unit 104 extends from a bottom of the floating platform 106 (i.e., the portion of the floating platform 106 in contact with the surface fluid body 102) into the fluid body 102. The water treatment system 100 can target any body of water from a small lake to manure lagoons and agricultural/industrial wastewater treatment.

The floating platform 106 can be made of any suitable material that will float at the surface of the fluid body 102 while sturdy enough to maintain the position of and connection with the columnar unit 104. Non-limiting examples of materials that can be used to form the columnar units 104 include aluminum, zinc-plated steel, and plastic. Additionally, the floating platform 106 can be formed in any suitable size and shape to meet the requirements of the fluid body 102 as well as to support the one or more columnar units 104. Non-limiting examples of materials that can be used for forming the floating platform 106 include polyethylene, acrylonitrile butadiene styrene (ABS), and polycarbonate.

The columnar unit 104 can be permanently fixed with the floating platform 106 or detachably attachable with the floating platform 106. For instance, there can be an aperture sized and formed within the floating platform 106 to receive and secure the columnar unit 104. Alternatively, a circular frame (or other shaped frame) with mounting flanges or eyelets for attaching to a framework of the floating platform 106 can be attached to each columnar unit 104 with screws, rivets, or any other suitable attachment mechanism to connect each columnar unit 104 with the floating platform 106. Furthermore, an engineered solution can be manufactured into the columnar unit 104 that allows for easy detachment for over-land transport of the water treatment system 100 by truck-load.

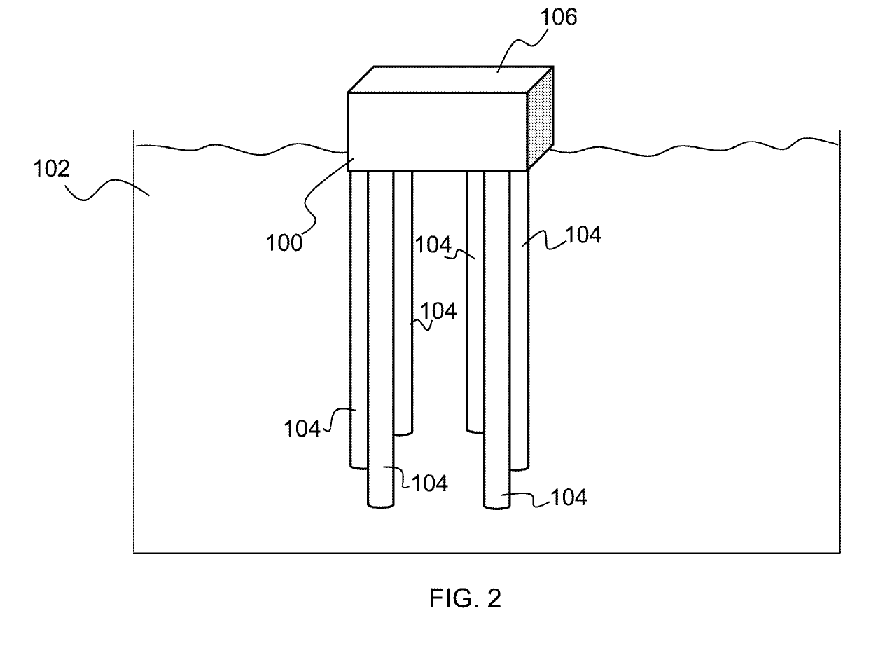

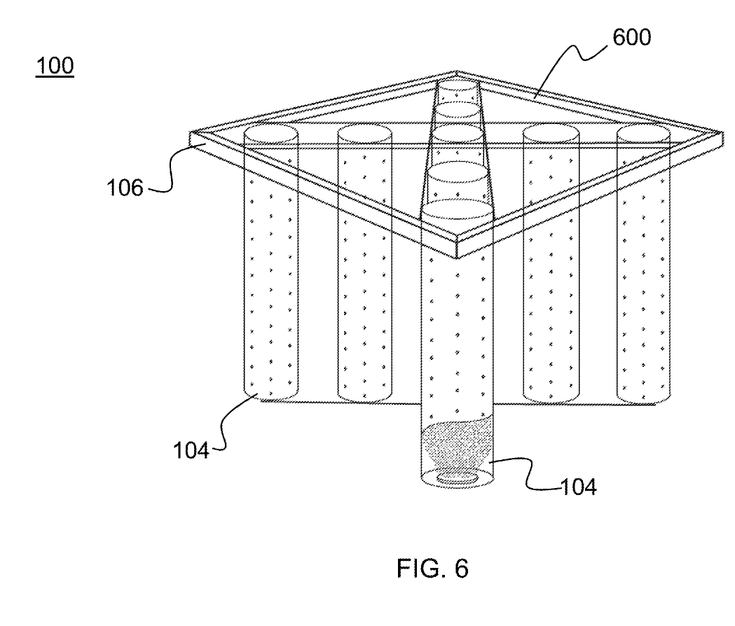

In another embodiment, and as shown in FIG. 2, a plurality of columnar units 104 can be connected with the floating platform 106. As can be appreciated by one skilled in the art, the columnar units 104 can be connected with the floating platform 106 in any type of arrangement (e.g., vertical arrangement, horizontal arrangement, close together, spaced apart, cross arrangement, circular arrangement). In another embodiment, the floating platform 106 is comprised of one or more flotation elements and a frame (FIG. 6, element 600) for attaching (or anchoring) one or more columnar units 104. The floatation element(s) and the frame 600 can be separable or fixed elements depending on the overall size of the floating platform 106.

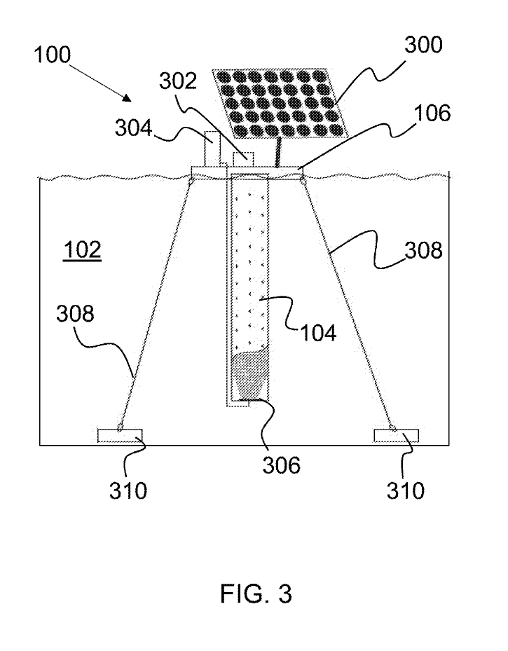

In one embodiment, the water treatment system 100 can be moved via a vehicle (e.g., truck) after it has performed its process on a given fluid body 102. Alternatively, the water treatment system 100 can be permanently installed in areas of high influent of ammonia. For instance, the floating platform 106 can be configured to be stationary and itself anchored to the bottom or sides of a fluid body 102. For example, anchor cables (FIG. 3, element 308) or chains can be affixed via anchors (FIG. 3, element 310) to the bottom or a side of the fluid body 102 and to the floating platform 106 through bolted means, attached via winch means electronically controlled to keep correct tension while allowing the tide to ebb and flow or in case of a controlled dam, to allow the rising or falling water level to have no effect on position. Alternatively, the floating platform 106 can be free floating with no permanent attachment to the boundaries of the fluid body 102.

As depicted in FIG. 3, power can be supplied via an electric cable from an electric source on dry land or supplied via a solar panel 300 (or array of panels) for operation during the day. Furthermore, a combination of adequate solar power to charge the power supply 302 (e.g., batteries) in conjunction with operation could be employed in an anchored configuration (shown in FIG. 3). Power is consumed for running an air-compressor 304 supplying an air diffuser 306 at the bottom of each columnar unit 104 (as described below). Sensors, data recording, and process control electronics also require electricity from the power supply 302.

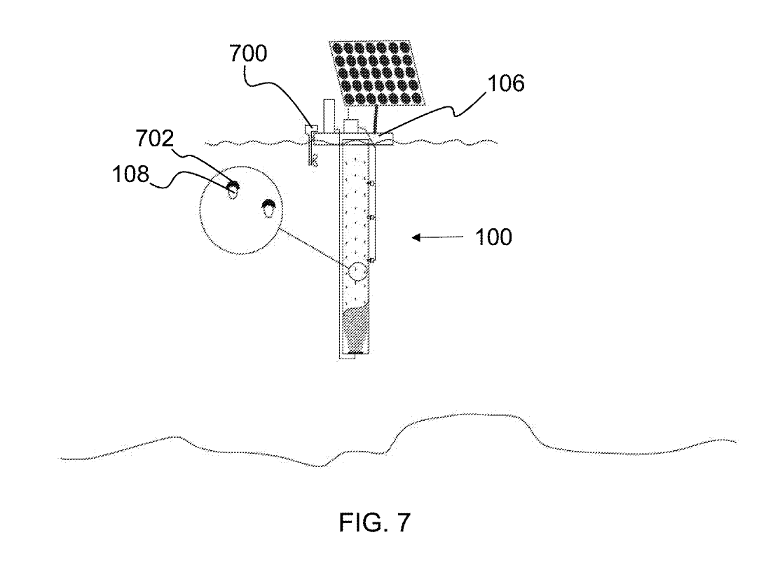

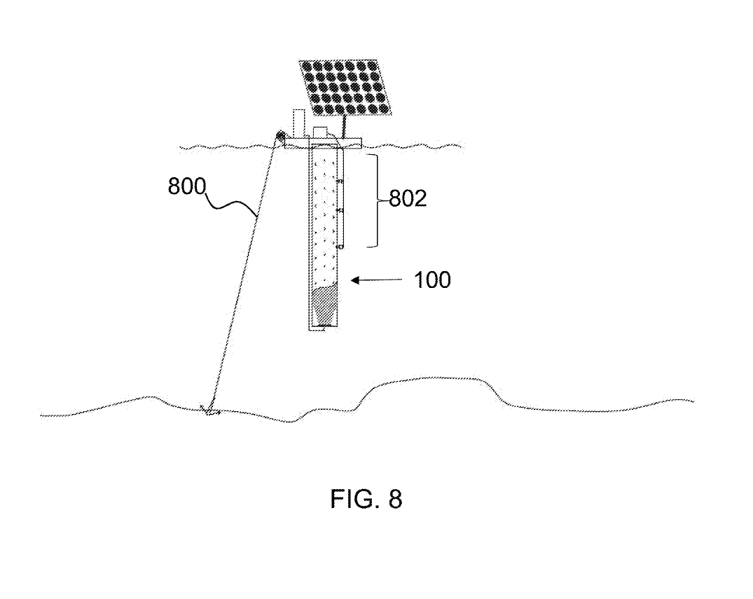

In the non-anchored autonomous operational embodiment of the floating platform 106, the floating platform 106 is powered by solar and/or battery (elements 300 and/or 302) and has a propulsion system (FIG. 7, element 700) that would allow movement within the fluid body 102. In addition, the floating platform 106 can include sensors (FIG. 8, element 802) for recording, monitoring, and processing chemical data in order to generate a report or alert of results. Non-limiting examples of sensors (FIG. 8, element 802) include an array of chemical sensors capable of detecting DO (dissolved oxygen), pH (hydrogen ion activity, aka acidity or alkalinity), and ion selective sensors for ammonium and nitrate, which can be connected to an on-board data-recording processor, can be standalone, or can be in communication with on-board process control electronics, as well as communicating wirelessly with a central control room, or research laboratory. Reporting and generation of alerts can be accomplished via wireless communication methods.

Moreover, the floating platform 106 can include a system for two-way communication, where the floating platform 106 receives updates to an on-board navigational system as well as nitrification process programming. Two way communication can be performed, for instance, via radio or cellular phone. More generally, the two-way communication system is a transceiver (which itself is a contraction or transmitter and receiver), in other words a device capable of sending and receiving electronic signals. As can be appreciated by one skilled in the art, there are many technologies that can accommodate the two way function and hundreds of different frequencies or frequency-bands that are specifically reserved for communication.

The navigational system on-board the floating platform 106 can comprise a programmable (physically or wirelessly) computer/processor that is referencing a Global Position System (GPS), or other suitable system, to enable autonomous navigation on the surface of the water. For instance, the processor can receive instructions based on GPS for controlling a propulsion mechanism 700 (via steering and acceleration) for autonomous movement of the floating platform 106. The control system is connected to a propulsion mechanism 700 (e.g., electric propulsion motors/propellers) attached with the floating platform 106, as shown in FIG. 7.

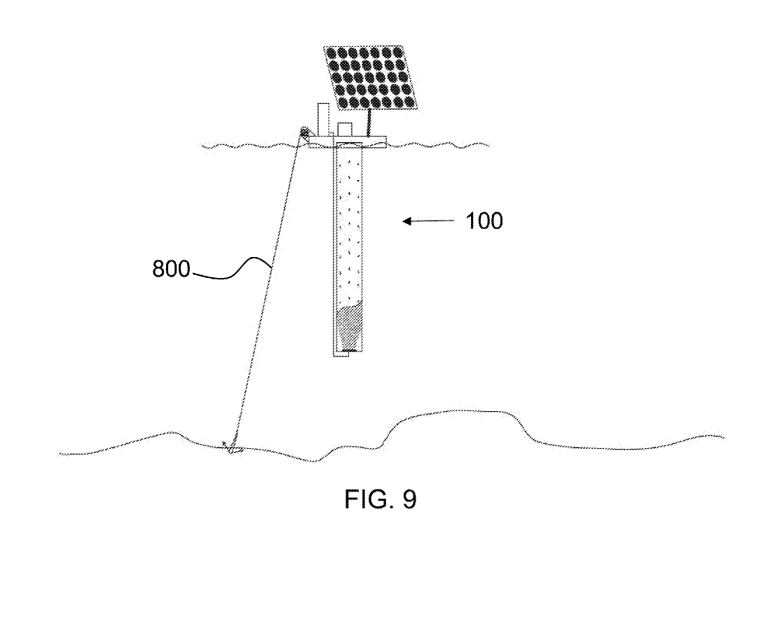

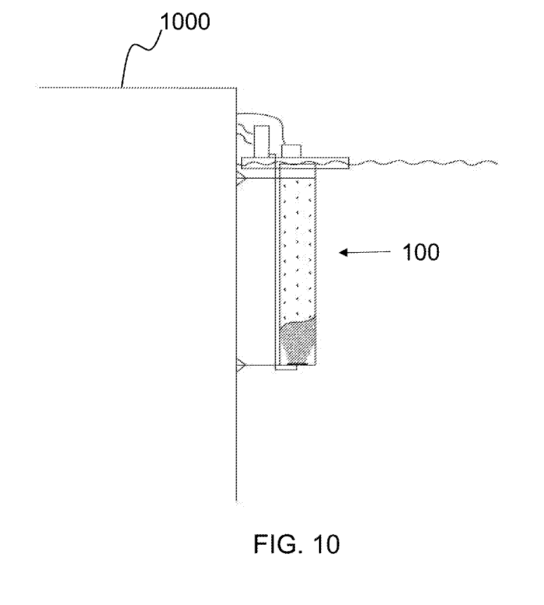

The floating platform 106 can also include an anchor/winch combination operated by the same control system to enable stationary positioning in strong wind or current conditions without constant consumption of electricity. FIG. 8 is an illustration of the water treatment system 100 anchored by a winch 800 and having sensors 802 for monitoring the water system (as described in detail below). FIG. 9 depicts the water treatment system 100 anchored by a winch 800 without sensors. FIG. 10 shows the water treatment system 100 anchored to the side of a structure 1000 (e.g., building, dock).

For nitrification process programming, the DO, ammonium, and nitrate sensors 802 can be monitored by a pre-programmed control system to provide the targeted nitrification conditions. DO is a key indicator in how efficient bacterial colonies are converting ammonia to nitrite (as an example) at a given time. Since energy is required to drive the air compressor 304, shore power, solar power (element 300) and/or batteries are required for this purpose. Additionally, there is a need to conserve energy. In some cases, the overall ammonia load may be low, so there would be less of a requirement for compressed air to drive the nitrification cycle.

Since aeration inside the columnar units 104 can be monitored by the DO sensor 802, and the rate of oxygen consumption by the bacteria is dependent on the mass of the bacterial colonies in total (and the mass is at least partially controlled by the amount of ammonia in the water), the system can adjust the amount of air flow volume supplied by the air diffuser 306 through electronically actuated valves to meet the optimal DO ratio. Since the bacterial mass is variable, and the air supply from the air diffuser 306 is also variable, the system can operate at the highest nitrification efficiency throughout the operations.

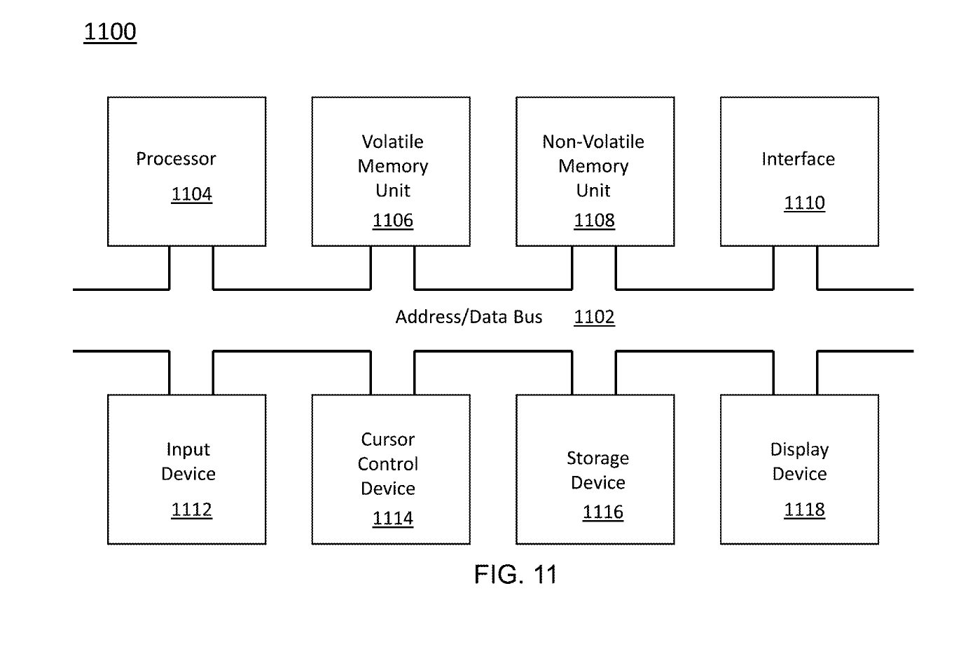

Based on sensor input, an on-board computer having a processor (element 1104, FIG. 11) can be programmed to open and close one or more electronically controlled valves which, in turn, control the amount of DO through a sensor/computer/compressed air supply/valve/air diffuser feedback loop. As can be appreciated by one skilled in the art, the on-board computer will have an algorithm based control loop that acts as a result of sensor feedback with the end result being a DO ratio that facilitates efficient nitrification in the environment surrounding the water treatment system 100. In one embodiment, the at least one electronically controlled valve is located proximate the air compressor 304, in order for the valve(s) to be easily serviceable. However, the valve(s) could also be located anywhere between the air compressor 304 and the air diffuser 306. Further, the air compressor 304 can be controlled via variable speed. Variable speed can accommodate a range of different CFM (cubic feet per minute) flow rates given a buffer, such as a small compressed air tank, which, when combined with the valves, will be very effective in achieving the target DO ratio.

As depicted in FIG. 1, the columnar unit 104 (e.g., columnar tube) may comprise at least one aperture 108 therein, allowing fluid inside the columnar unit 104 to be in communication with fluid outside the columnar unit 104 (i.e., the fluid body 102). In one aspect, and as shown in FIG. 1, the columnar unit 104 comprises a plurality of apertures 108 positioned at various locations along the columnar unit 104. As can be appreciated by one skilled in the art, the apertures 108 can be formed of any suitable size and shape provided that the apertures 108 allow the flow of fluid into and out of columnar unit 104. Additionally, the apertures 108 can be positioned at any location along the surface of the columnar unit 104. For instance, the apertures 108 may be positioned only at the top and bottom, only on a side, front and back, etc.

In one aspect shown in FIG. 7, the apertures 108 may include a curved protrusion 702, or lip, that extends slightly over the top of the apertures 108 (i.e., a small extension of the surface) to catch bubbles that are going up. Alternatively, the apertures 108 may include a curved protrusion that extends below the apertures 108 to avoid entry of bubbles. Any combination of curved protrusion 702 (i.e., above or below an aperture 108) or apertures 108 without protrusions can be utilized.

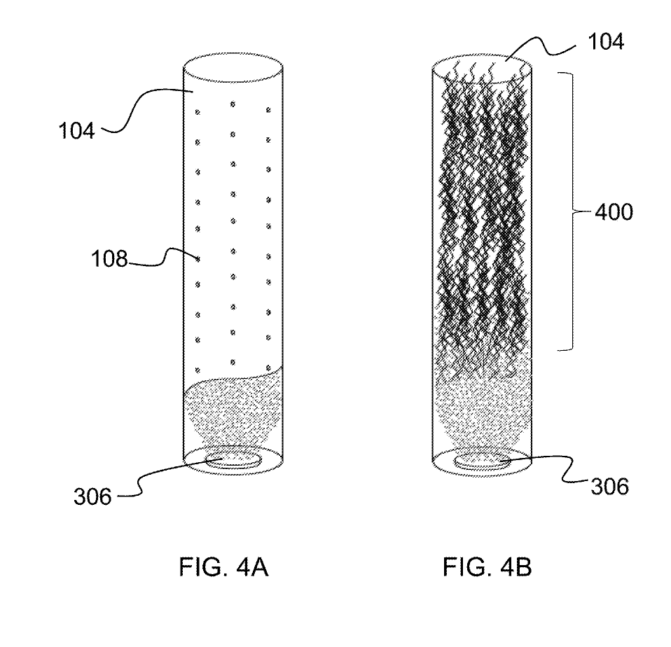

FIG. 4A is an illustration of a single columnar unit 104 having a plurality of apertures 108 throughout the length of the columnar unit 104. In addition, this embodiment depicts an aeration device (e.g. air diffuser 306) positioned at the bottom of the columnar unit 104. The air diffuser 306 provides oxygen to create the relatively oxygenated region. An air diffuser 306 (or membrane diffuser) is an aeration device used to transfer air and oxygen into sewage or industrial wastewater. As can be appreciated by one skilled in the art, other aeration devices can be used, such as a venture pump.

FIG. 4B depicts a columnar unit 104 having a string like substrate 400 for increasing surface area to encourage bacterial colonies to attach and grow on the substrate 400. The substrate 400 is an important aspect in “clear water” operations of the columnar units 104, because there is no access to activated sludge as a bacterial carrier. Since bacteria is needed for the nitrification process and bacteria likes to attach itself to a substrate 400 in a nutrient rich environment, a high surface area to occupied volume ratio substrate 400 is used to maximize bacterial colonies. The substrate 400 can be made of any suitable material but as a non-limiting example, plastic strings can be used. For instance, an acrylonitrile butadiene styrene (ABS) plastic substrate made by machining the material in a lathe, which produces small diameter curly strands or strings, can be utilized. In one embodiment, the substrate 400 is enclosed in a tubular mesh (to prevent it from floating to the top) which allows even distribution throughout the length of the columnar unit 104. The substrate 400 can also be manufactured from a buoyant material which is attached with or anchored to a perforated disc that is mounted in the columnar unit 104 in relation to the air diffuser 306.

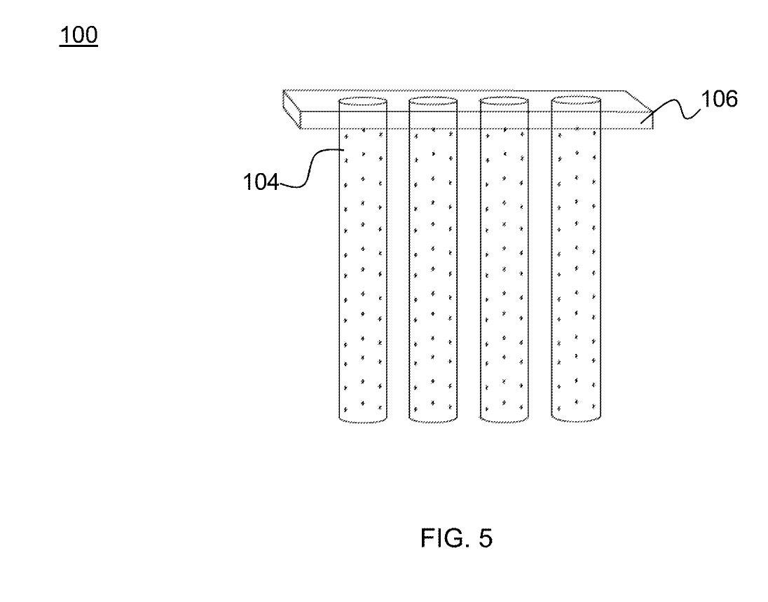

As shown in FIGS. 5 and 6, the plurality of column units 104 can be arranged and connected with the floating platform 106 in any suitable manner, such as a horizontal arrangement (FIG. 5) or a cross arrangement (FIG. 6).

A block diagram depicting an example of a system (i.e., computer system 1100) of the present invention is provided in FIG. 11. The computer system 1100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 1100. When executed, the instructions cause the computer system 1100 to perform specific actions and exhibit specific behavior, such as described herein. The one or more processors may have an associated memory with executable instructions encoded thereon such that when executed, the one or more processors perform multiple operations. The associated memory is, for example, a non-transitory computer readable medium.

The computer system 1100 may include an address/data bus 1102 that is configured to communicate information. Additionally, one or more data processing units, such as a processor 1104 (or processors), are coupled with the address/data bus 1102. The processor 1104 is configured to process information and instructions. In an aspect, the processor 1104 is a microprocessor. Alternatively, the processor 1104 may be a different type of processor such as a parallel processor, or a field programmable gate array.

The computer system 1100 is configured to utilize one or more data storage units. The computer system 1100 may include a volatile memory unit 1106 (e.g., random access memory (“RAM”), static RAM, dynamic RAM, etc.) coupled with the address/data bus 1102, wherein a volatile memory unit 1106 is configured to store information and instructions for the processor 1104. The computer system 1100 further may include a non-volatile memory unit 1108 (e.g., read-only memory (“ROM”), programmable ROM (“PROM”), erasable programmable ROM (“EPROM”), electrically erasable programmable ROM “EEPROM”), flash memory, etc.) coupled with the address/data bus 1102, wherein the non-volatile memory unit 1108 is configured to store static information and instructions for the processor 1104. Alternatively, the computer system 1100 may execute instructions retrieved from an online data storage unit such as in “Cloud” computing. In an aspect, the computer system 1100 also may include one or more interfaces, such as an interface 1110, coupled with the address/data bus 1102. The one or more interfaces are configured to enable the computer system 1100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 1100 may include an input device 1112 coupled with the address/data bus 1102, wherein the input device 1112 is configured to communicate information and command selections to the processor 1100. In accordance with one aspect, the input device 1112 is an alphanumeric input device, such as a keyboard, that may include alphanumeric and/or function keys. Alternatively, the input device 1112 may be an input device other than an alphanumeric input device. In an aspect, the computer system 1100 may include a cursor control device 1114 coupled with the address/data bus 1102, wherein the cursor control device 1114 is configured to communicate user input information and/or command selections to the processor 1100. In an aspect, the cursor control device 1114 is implemented using a device such as a mouse, a track-ball, a track-pad, an optical tracking device, or a touch screen. The foregoing notwithstanding, in an aspect, the cursor control device 1114 is directed and/or activated via input from the input device 1112, such as in response to the use of special keys and key sequence commands associated with the input device 1112. In an alternative aspect, the cursor control device 1114 is configured to be directed or guided by voice commands.

In an aspect, the computer system 1100 further may include one or more optional computer usable data storage devices, such as a storage device 1116, coupled with the address/data bus 1102. The storage device 1116 is configured to store information and/or computer executable instructions. In one aspect, the storage device 1116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 1118 is coupled with the address/data bus 1102, wherein the display device 1118 is configured to display video and/or graphics. In an aspect, the display device 1118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 1100 presented herein is an example computing environment in accordance with an aspect. However, the non-limiting example of the computer system 1100 is not strictly limited to being a computer system. For example, an aspect provides that the computer system 1100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

What is claimed is:

1. A system for simultaneously removing ammonia and nitrates from a liquid, the system comprising:
a floating platform;
at least one columnar unit connected with the floating platform, each columnar unit having a top, a bottom, and a bounding surface extending from the top to the bottom, wherein the bounding surface possesses a plurality of apertures;
an air diffuser connected with the at least one columnar unit for supplying an air flow volume within the at least one columnar unit;
a compressed air supply; and
a power supply.

2. The system as set forth in claim 1, further comprising a propulsion mechanism attached with the floating platform.

3. The system as set forth in claim 1, further comprising a substrate for bacterial growth residing within the at least one columnar unit.

4. The system as set forth in claim 1, further comprising at least one solar panel attached with the floating platform.

5. The system as set forth in claim 1, further comprising a frame for attaching the at least one columnar unit with the floating platform.

6. The system as set forth in claim 1, wherein the floating platform is anchored to one of a bottom of a fluid body and a side of a structure.

7. The system as set forth in claim 1, further comprising at least one sensor for recording chemical data.

8. The system as set forth in claim 7, wherein the at least one sensor is a dissolved oxygen sensor for monitoring aeration inside the at least one columnar unit.

9. The system as set forth in claim 2, further comprising a processor for receiving instructions for controlling the propulsion mechanism for autonomous movement.
